(19) United States
(12) Patent Application Publication
(10) Pub. No.: US 2018/0102992 A1
(43) Pub. Date: Apr. 12, 2018

(54) Controlling Permissions in a Communication System

(71) Applicant: Microsoft Technology Licensing, LLC, Redmond, WA (US)

(72) Inventors: Oleksandr Dmytrovych Pysanets, Prague (CZ); Janine Ruth Crumb, Seattle, WA (US); Lukas Barton, Prague (CZ)

(73) Assignee: Microsoft Technology Licensing, LLC, Redmond, WA (US)

(21) Appl. No.: 15/290,774

(22) Filed: Oct. 11, 2016

(51) Int. Cl. H04L 12/58

(52) U.S. Cl. CPC H04L 51/046; H04L 51/12; H04L 51/38

(57) ABSTRACT

A first user terminal receives an incoming communication via a communication system originating from a second user of a second user terminal, the second user net yet being a contact of the first user. In dependence on one or more factors relating to the incoming communication, an automatic selection is performed between: a) prompting the first user with a quarantine experience in a user interface on the first terminal upon the receipt of the incoming communication, the quarantine experience offering the first user an option to block further attempts by the second user to communicate with the first user via said communication system, or instead b) prompting the first user with little or no quarantine experience upon the receipt of said incoming communication.

### BACKGROUND

Various technologies exist which enable users to conduct communications over a computer network, whether the network in question is the Internet or another type of network such as a company intranet. These technologies include instant messaging (IM), voice calls such as voice-over Internet Protocol (VoIP) calls, video calls, sharing still images (picture messaging), sharing video clips (video messaging), screen-sharing streams, remote slide presentations, and virtual whiteboards, and sharing one's geographic location.

The personal security of users is an issue, and therefore such communication systems often work based on the principle of contacts. This means that the system maintains a contact list for each user, typically on a server (where a server herein may refer to a logical server comprising one or more server units located at one or more geographical sites). The contact list is a list of other users of the communication system whom the user in question has accepted as contacts. Contacts and non-contacts are granted different permissions. Particularly, the way in which other users can communicate with a given user, and the information they can view about that user, is limited until accepted as contact.

For example, as a default setting, other users may be allowed to send a call request to initiate a voice or video call but cannot send IM messages to a given user until that user has accepted the other user as a contact. Other restrictions may also apply. E.g. the user's presence state, geographic location, status message (sometimes also called a “mood message”) and certain information from the user's profile may not be made available to other users until they have been accepted as a contact. In some cases, these permissions can be changed via user settings.

To send a contact request, the requesting user searches for the desired recipient user using a search tool of the communication system, and then assuming the user in question is found, the requesting user selects to send a contact request to the recipient. When the contact request is received by the recipient user, this user is presented with buttons providing explicit options as to what to do with the contact request, e.g. options such as to accept, block, ignore and/or report as spam. This is sometimes referred to as a “quarantine experience”.

### SUMMARY

It is also desirable to try to maximize the number of potential connections that can be formed between users in a network in order to increase the utility of the system. However, the contacts-based model in fact restricts the set of available connections between users. Particularly, as recognized herein, the quarantine experience forms a potential barrier to forming connections between users.

There is therefore a conflict: on the one hand the users' security needs to be preserved, but on the other hand it is desirable to try to maximise the utility of the system in terms of interconnectivity between users. It would be desirable to retain the contacts-based model for security purposes. Nonetheless, while to some extent a contact-based system will always impose some restriction in terms of connectivity, it is recognized herein that there is still scope to facilitate the building of a more complete graph of available connections by removing barriers to users accepting one another as contacts.

In existing systems, the quarantine experience is not displayed if the sending user is already a contact, but otherwise the quarantine experience is always imposed. As recognized herein, it would be desirable to provide a smarter way to select when and when not to impose the quarantine experience, and thereby break down some potential barriers to the creation of new communication channels between users. Accordingly, the present disclosure provides a selective quarantining mechanism which takes into account one or more “signals” relating to the circumstances or nature of the incoming communication. E.g. such signals may comprise: whether the sending user and the receiving user already have a contact in common (“friend of a friend”), or a certain number of contacts in common; and/or whether they are already connected through some other means such as having already participated in one or more multiparty conversations created by a third user, or having already joined a same group such as a same interest group in a social media system.

According to one aspect disclosed herein there is provided a method in which, from a first user terminal, a first user accesses a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system (said one or more permissions not being granted to any of said other users who are not amongst the contacts). The method comprises, at the first user terminal, receiving an incoming communication via said communication system, the incoming communication originating from a second user of a second user terminal, and the second user being one of the other users who is not yet one of the contacts of the first user. Further, in dependence on one or more factors relating to the incoming communication, an automatic selection is performed to select between: a) prompting the first user with a quarantine experience in a user interface on the first terminal upon the receipt of said incoming communication, the quarantine experience offering the first user an option to block further attempts by the second user to communicate with the first user via said communication system, or instead b) not prompting the first user with a quarantine experience or only prompting the first user with a reduced quarantine experience upon the receipt of said incoming communication, such that the second user can be accepted as one of said contacts without the first user being prompted with a quarantine experience or with the first user only being prompted with the reduced quarantine experience.

Thus the present disclosure provides a mechanism which can still guard against unwanted communications such as spam or abuse from nuisance users, but which at the same time also allows a more fluid experience for connecting users by removing the quarantine experience where it can be estimated that there is no need for such a barrier to exist.

In embodiments, b) comprises not prompting the first user with a quarantine experience at all, such that the second user can be accepted as one of said contacts without the first user being prompted with a quarantine experience.

Note that in embodiments, said one or more factors may be evaluated at the first user terminal, or alternatively these one or more factors may instead be evaluated at a server (comprising one or more server units at one or more geographical sites). In the latter case, said automatic selection in dependence on said one or more comprises: the first user receiving from the server an indication as to a result of the evaluation performed at the server, or an indication as to which of a) and b) to select based on the evaluation performed at the server; and the first user terminal acting upon said indication from the server. In embodiments, the selection would also be based on a combination of an evaluation performed partially at the server and partially at the first user terminal.

In embodiments, the method may further comprise: providing an implicit contact acceptance mechanism through the user interface on the first terminal, whereby in response to the first user sending a reply to said incoming communication back to the second user via said communication system (the reply comprising user content composed, captured or chosen by the first user) then the second user is automatically added as one of said contacts without the first user having to actuate any explicit contact acceptance control.

Thus when the first user interacts with the second user, such as by replying to an IM or answering an incoming call, this is taken as an implicit acceptance of the second user as a contact. Advantageously this helps to further break down a barrier to forming connections between users, whilst at the same time retaining the security of a contact-based model. Particularly, contact requests are often passively ignored (as opposed to the receiving user explicitly selecting to ignore the request), even though the receiving user may in fact know the user sending the contact request, and sometimes may even have communicated with that user over the system via one of the non-restricted modes of communication (e.g. VoIP call). The implicit contact acceptance mechanism preserves the contact model, but provides a more fluid mechanism for forming contacts and thereby augmenting the total connectedness of the system.

For example, the message received in the contact request may be displayed in the conversation pane almost as if it was any other IM message, and if the first user replies with an IM message entered through the IM field (the same field that is used for IM conversations generally) then the system infers that the second user is known by the first user and therefore can be added as a contact. In embodiments, the first user could also cause the second user to be accepted by reply with other types of message such as a picture message, video message or shared location.

According to another aspect disclosed herein, there is provided a computer program product embodied on computer-readable storage and configured so as when run on one or more processors to cause the disclosed method to be performed. The computer-program product may take the form of a client application for running on the first user terminal. Alternatively, the computer-program product may take the form of a web client for being hosted on a server, to be accessed by the first terminal via the Internet.

According to another aspect disclosed herein, there is provided a network element configured to perform the method according to any of the embodiments disclosed herein. The network element may be the first user terminal, or may be a server (comprising one or more server units at one or more geographical sites).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of a communication system,

FIG. 2 is a schematic mock-up of a user interface of a client application, and

FIG. 3 is another schematic mock-up of a user interface of a client application.

### DETAILED DESCRIPTION OF EMBODIMENTS

As discussed above, existing communication clients such as VoIP and IM clients have a contact request flow that slows down communication. There is a burden at the sender's side, where in order to start the communication the sending user has to send a contact request to the intended recipient and then wait until he or she is accepted. The user at the receiving side also has to be prompted to interact with a quarantine experience comprising block/accept controls or the like. Only after all this can the real conversation be started. It would be desirable to improve this mechanism such that users can more readily connect with one other, thereby reducing the number of user interactions before a conversation can begin, and increasing the overall connectedness of the system (the number of interconnections available in the graph of connections between users).

In embodiments, this is achieved by removing the contact request from the sender's side and allowing users to straightaway send messages to other users they have no connection with. In embodiments the number of first messages that can be sent before being accepted as a contact may be limited, and may be configurable globally and/or per user (both for the sending and receiving sides).

On the recipient side, it is desirable to retain some protection by leaving the ability for the user to authorize or block incoming communications from people they have no connection with yet. In embodiments, the recipient will be able to block a sender and report abuse.

In some scenarios, the user experience will be the same as with current clients, i.e. a pop-up with options to report an abuse or spam, or to accept the sender to become a contact. In case the block button is clicked, the local chat history (but in embodiments not the cloud stored history) with the blocked user is automatically cleaned up to erase potentially bad content form receiving user's device, and the blocked user has to be removed from the contact list. If this user is later unblocked, in embodiments the chat history will be synced back from the cloud and the user will appear in the contact list just as before.

However, it would also be desirable to minimize number of times this quarantine experience is presented to the receiver, and to go fully Invite-free whenever possible. In the current generation of clients, the only time the quarantine experience is dispensed with is when the sender and receiver are already contacts of one another within the communication system in question (e.g. the particular VoIP and/or IM system operated by a particular party). However, to make this more flexible, in embodiments one or more of the following rules may be applied to let messages go through without quarantine experience: (i) the sender has a verified phone number or email that appears in the receiver's address book. (ii) the sender has any phone number or email on their profile or account that appears in the receiver's address book, (iii), the sender and receiver have more than x friends in common in the people graph (and in embodiments x is a configurable number), (iv) the sender and receiver have common group conversation in their chat history, and/or (v) the sender and receiver share the same location (e.g. as detected based on network information or GPS information).

Another example rule may be that all calls are allowed to happen without any relationship check, but other types of communication such as IM do require a relationship check before dispensing with the quarantining. Or in variants of the, the quarantining for calls may be contingent on one or more characteristics associated with the sender, e.g. if a user has good reputation then he or she can call to anyone. A sender's reputation may be measure for example based on a ratio of times the sender has been accepted or blocked as a contact over various attempts to contact other users, or based on a spam rate of the sender, or a sending velocity. The reasoning behind a more permissive approach for calls than IMs or such like, is that calling is not big spam vector in VoIP systems, and also the majority of users already allow calls from anyone anyway through their privacy settings.

In embodiments such rules may evolve over time, and therefore in embodiments it may be desirable for this logic to reside server-side and not on the client.

To ignore or decline the conversation the receiving user can simply leave it and let it hang in the recent list, where it will go to the bottom and get deleted eventually. Also the receiving user can hide or delete the conversation from the recent list by standard means of the client application.

Some exemplary embodiments will be discussed in more detail shortly, but first an overview is given of an example communication system in which embodiments of the present disclosure may be embodied.

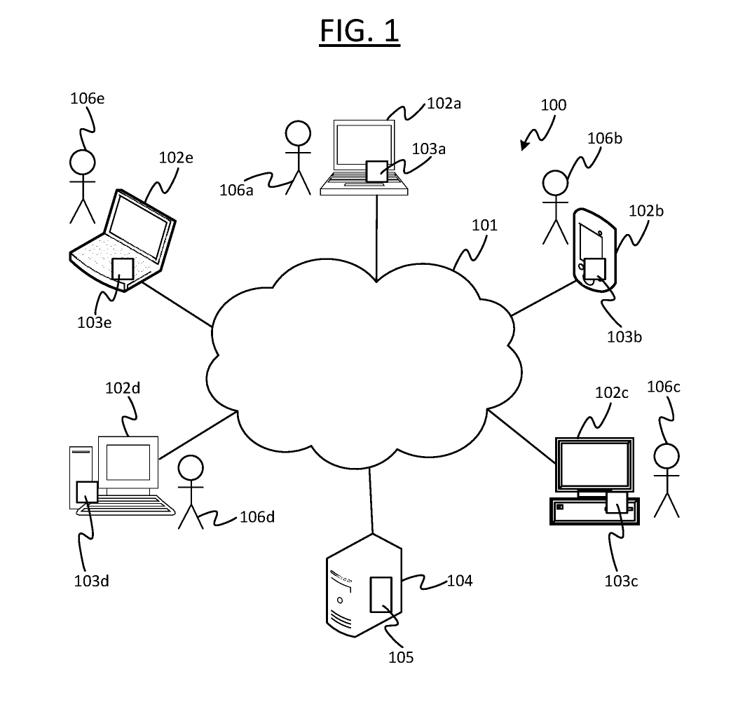

FIG. 1 schematically illustrates a communication system 100 in accordance with embodiments disclosed herein. The communication system comprises a plurality of user terminals 102 each configured to connect to a computer network 101, and each installed with a respective instance of a communication client application 103. Each of the user terminals 102 is also used by at least one respective user 106. In FIG. 1, five user terminals 102a-e and their respective clients 103a-e and users 106a-e are shown for illustrative purposes, but it will be appreciated that there may be different numbers of user terminals 102 involved in other scenarios covered by the present disclosure. The network 101 is preferably a packet-based network. In embodiments it may take the form of a wide-area internetwork such as that commonly referred to as the Internet. Alternatively, the network 101 may take the form of another type of network such as a company intranet, a mobile cellular network, or a wireless local area network (WLAN), or a combination of any of these and/or the Internet.

Each of the user terminals 102 may take any of a variety of different forms, such as a desktop computer, laptop, tablet, smartphone, smart watch, pair of smart glasses, smart TV, set-top box, or conference room phone unit (and the different user terminals 102 need not necessarily take the same form as one another). Note therefore that the term “computer” as used herein does not restrict to a traditional desktop or laptop computer.

The communication clients 103 are each installed on computer-readable storage of their respective user terminal 102, and arranged for execution on a respective processing apparatus of the respective user terminal 102. The storage may take the form of one or more storage media (e.g. magnetic memory, electronic memory and/or optical memory) implemented in one or more memory units. The processing apparatus may take the form of one or more processing units. Each of the communications clients 103 is configured so as to be able to establish a communication session with one or more others of the communication clients 103 running on one or more of the other respective user terminals 102. The user of each user terminal 102 is then able to send messages to each other of the users of each other of the user terminals 102 participating in the session. In embodiments, the messages may include any one or more “traditional” types of message such as: IM messages, live voice (e.g. VoIP) streams (of the sending user's voice), and/or live video streams (e.g. a head-and-shoulders shot of the sending user). Alternatively, or additionally, the messages may include one or more other types of message such as: still images (picture messaging), pre-recorded video clips (video messaging), pre-recorded audio clips (e.g. voice mail), a shared geographical location (e.g. as detected by a localization system such as GPS), screen sharing streams, remote slide representations, and/or electronic or virtual whiteboard streams.

In embodiments the communication system 101 comprises a server 104 connected to the network 101, arranged to provide a communication service via which the communication session is at least in part conducted. In such embodiments, the message from any given one of the users is sent from the sending user terminal, e.g. 102a, to the server 104, and the server 104 is configured to forward the message on to each of the recipient user terminals 102b-e.

Note also, in yet further embodiments, the system need not comprise a communication client 103 installed on each user terminal 102. For instance, alternatively one, some or all of the user terminals could instead be installed with a general purpose web browser operable to access a web-based version of the client application (“web client”) hosted on the server 104. In such cases the described functionality may be achieved by the web-client rather than the locally installed client (i.e. client installed locally on an individual user terminal 102). Or more generally, the functionality disclosed herein can be implemented by any combination of a local client application 103 (on each user terminal 102) and/or server hosted functionality (e.g. a web client). For conciseness the various options in this respect will not be repeated each time the functionality below is described, but it will be understood that these options apply throughout.

Regardless of whether a local client is installed on each user terminal 102 or whether a server-hosted client is used, the server 104 may also be arranged to provide additional functionality in association with the communication service. Particularly, the server 104 maintains a contact a list 105 for each of the users 106. The contact list 105 for a given user is a list of the other users which that user has accepted as contacts. This will be discussed in more detail shortly. Note: it is not essential to store the contact lists centrally at a server 104. Instead the contact list for a given user could be stored on the user's own user terminal 102. However, that would mean the contact list was not necessarily available to that user when he or she logged on from a different device 102. As another alternative, the contact list could be stored in a distributed P2P database. However, users may not be comfortable having their personal details stored in this manner.

The server 104 may optionally also keep additional, supplementary information for each of the users 106, such as a respective user profile, a respective status message, a respective presence status, and/or respective location information. This supplementary information is made available from the server 104 via the network 101 to at least some others of the users 106b-e. In embodiments, some or all of this information may only be able available to any other users of the service whom the user in question has accepted as a contact.

The information in each user's profile may comprise for example any one or more of: an email address of the respective user, a profile picture of the respective user, a place of residence of the respective user, and/or a time zone or local time of the respective user, etc. The respective profile information for a given user is typically set by that user him- or herself, via the respective client application 103 which sends it to be stored at the server 104.

The status message is sometimes also referred to as a “mood message”. It is a brief statement composed by the respective user him- or herself as to his or her current state of being, e.g. “Feeling good as the sun is out today” or “OOO, back in Monday 25^{th} January”.

The presence status indicates the user's availability for communication within the communication system, e.g. selected from a set comprising two or more of: do not disturb (DND), offline, inactive or available. In embodiments the presence status is determined at least partially automatically, e.g. by detecting when the user is not logged in and is therefore offline, and/or by detecting that if the user has not interacted with his or her user terminal 102 (e.g. has not moved the mouse) then he or she is inactive. DND is typically set manually by the respective user. The available state may be determined automatically if the user is neither offline nor inactive and has not selected DND. Some of the possible presence states may be detected by the client application 103 and reported to the server 104, e.g. whether the user is inactive. Other possible states may be detected directly by the server 104, e.g. whether the user is offline. Some possible states may be detected by either client 103 or server 104, e.g. whether the user has selected DND, and/or whether he or she is available.

The location information may be set manually by the respective user 106, but in embodiments it is detected automatically based on one or more location technologies, e.g. a satellite-based location technology such as GPS or Galileo, or by reference to other wireless nodes such as cell towers of a mobile communication system, anchor nodes of an indoor positioning system, or Wi-Fi hotspots, etc. The client 103 detects the location of the respective user terminal 102 and reports this to the server 104.

Note: with regard to this supplementary information (e.g. profile information, status message, presence state and/or location information), it is not essential to store this centrally at a server 104. However similar considerations as discussed in relation to the contact list 105 may apply. I.e. the information could be stored on the user's own user terminal 102, but that would mean it was not necessarily available to that user when he or she logged on from a different device 102; or the information could be stored in a distributed P2P database, but users may not be comfortable having their personal details stored in this manner.

The contact list 105 for a given user records which of the other users of the communication system that user has accepted as contacts. This in turn determines what permissions the other users are granted in relation to communicating with the user via the communication system, in dependence on whether they are each a contact or not. By way of illustration the following will be described from the perspective of a contact list 105 of a first user 106a of a first user terminal 102a, where the first user 106a is receiving a contact request from a second user 106b of a second user terminal 102b, but it will be appreciated that similar teachings can apply in relation to any combination of users.

There are at least two possible categories of permissions that the contact list determines. The first category defines the type of communication the second user 106b can establish with the first user 106a, or indeed whether or not the second user 106b can communicate with the first user 106a at all (at least via the communication system in question). For example, in embodiments the second user 106b is allowed to send a call establishment request to start a voice or video call (e.g. VoIP call) with the first user 106a without the second user 106a having been accepted as a contact of the first user 102a. This means the client 103a on the first user's terminal 102a will cause it to “ring” to alert the first user 106a to an incoming call, which the first user 106a can answer in the same way he or she would for a contact. However, in embodiments, the second user 106b cannot send other types of communication to the first user 106a without having first been accepted as a contact of the first user 106a. For example, the second user 106b may not be allowed to send IM messages, picture messages, video messages, voice mail and/or a shared location to the first user 106a until he or she is accepted as a contact of the first user 106a. In general, any combination of allowed and not-allowed communication types may be enforced for non-contacts.

As mentioned, the system may also store supplementary information such as a respective user profile, status message, presence status and/or location information in relation to the first user 106a. This supplementary information relates to the communication with the first user 106a via the communication system in that it is accessed via the same communication system and provides information that supplements the experience of communicating with the first user 106a. For instance, the presence state indicates whether the user is available to be communicated with; and the user profile, status message and/or location add context to the communication with the first user 106a (e.g. the experience of communicating with the first user 106a may be shaped or informed by knowing personal information about the user, or knowing that he or she is having a bad day, or that he or she is currently in a certain town or country).

The second category of permissions therefore defines what supplementary information of the first user 106a can be viewed by the second user 106b via the communication system. For instance, in embodiments the second user 106b is not allowed to view the first user's status message, presence nor location until the second user 106b has been accepted as a contact of the first user 106a. In embodiments, the second user 106b may be allowed to view certain selected parts of the first user's profile information via the communication system without having been accepted as a contact of the first user 106a, while other parts of the profile information may remain unavailable until accepted as a contact. In general, any combination of viewable and not-viewable supplementary information may be enforced for non-contacts.

In some embodiments, the permissions for the first user's contacts and non-contacts may be defined at least in part by a set of user preferences (i.e. settings) which can be set by the first user 106a him- or herself. These settings may be stored at the server 104 or locally on the user's own respective user terminal 102a (wherein similar considerations as to server-based or non-server-based storage location may apply as discussed in relation to the contact list and supplementary information such use user profile). Thus there are maintained a first set of permissions for the contacts and a second set of permissions for non-contacts (where the second set may be a subset of the first, or may overlap with the first), wherein one or more of these permissions can be set by the first user 106a as a user preference. These settable permissions may comprise one or more permissions in the first category, i.e. which communication types are not allowed for non-contacts, and/or one or more permissions in the second category, i.e. which types of supplementary information is visible to non-contacts (e.g. profile information, presence, etc.).

In embodiments, some of the preferences may have default settings which are in place when the first user's client application 103a is first installed on the first user terminal 102a, or when the first user 106a first registers with the communication system, but which the first user 106a can later override. E.g. default settings may be that non-contacts can make voice and video calls to the first user 106a but cannot send IM messages, picture messages, video messages or leave voice mail. Any combination of defaults in general is possible.

The present disclosure uses a contacts-based model such as that described above in order to prevent the system becoming open to abuse, but at the same time provides a more fluid mechanism for accepting contacts so as to increase to the number of available connections between users.

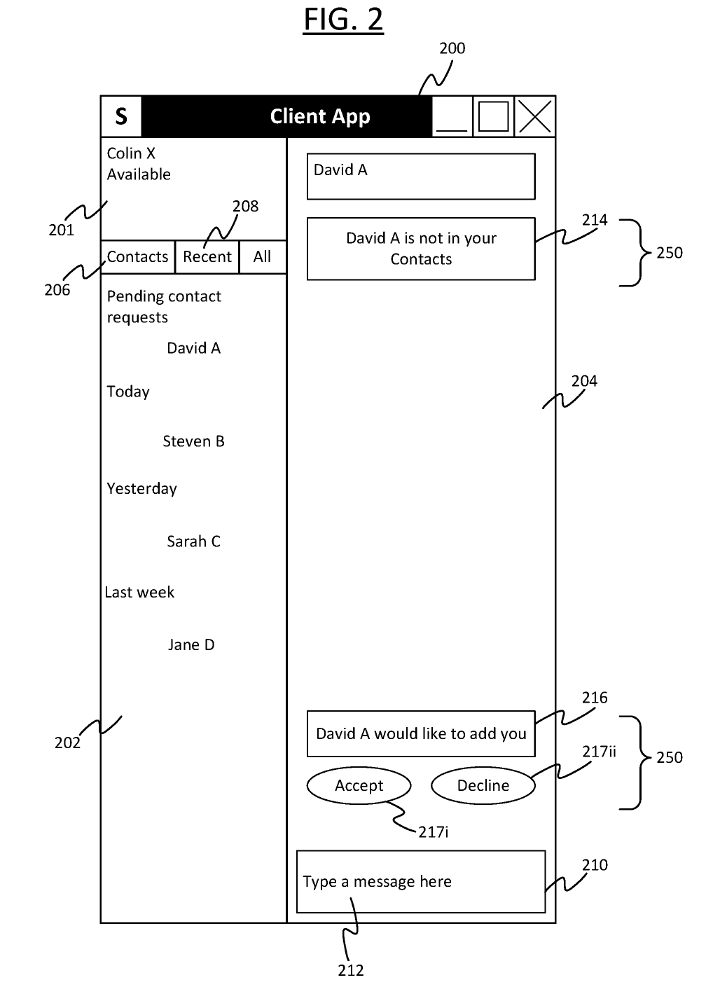

By way of comparison, an existing mechanism is first described in relation to FIG. 2. This shows the front-end user interface (UI) 200 of the client application 103a running on the first user's terminal 102a (or of the web client accessed from the first user's terminal 102a). The UI 200 comprises a plurality of UI areas such as a local user pane 201, a history pane 202 and a conversation pane 204. The local user pane 201 shows information about the first user 106a (the user of the terminal 102a on which the UI is displayed), e.g. his or her name, username, profile picture and/or presence state. The history pane 202 shows a list of conversations and contact requests that the first user 106a has been involved in or received over a certain time-window into the past. The conversation pane 204 shows the conversation or contact request that is currently selected in the history pane 202. The UI 200 may also comprise a user-operable contacts control 206 (e.g. a tab or button) and a user-operable history control 208 (e.g. again a tab or button). Actuating (e.g. clicking or touching) the contacts control 206 brings up a list 105 of the first user's contacts from which he or she can select to establish communications with those contacts. Actuating (e.g. clicking or touching) the history control 208 brings up the history pane 202. In the arrangement shown the contacts list pane would be displayed in place of the history pane 202 when the contacts control 206 is actuated, and vice versa, but this need not necessarily be the case.

The conversation pane 204 is where the first user actually conducts two-way conversations with other users (via the communication system in question). When another user sends a message to the first user 106a, it appears in the conversation pane 204. Also, the conversation pane 204 comprises a messaging field 210 in which the first user can enter messages to be sent to the user(s) 106 on the other end of the conversation. In the example shown, the conversation pane 204 comprises a note 212 to the first user 106a inviting him or her to type an IM message (a type of text based message) into the message field 210, thereby enabling the user to conduct an IM conversation with the other users. E.g. this may be displayed in the messaging field 210, perhaps greyed out. However, note that the term “conversation” as used herein does not limit as to the type of messages being exchanged. For example, the messages exchanged as part of the conversation may comprise any one or more of: text-based messages (e.g. IM messages), live voice and/or video streams (voice and/or video calls), still images (picture messages), pre-recorded audio clips (voice mail), pre-recorded video clips (video messages), a shared location, a slide show, a screen-share, content from an electronic or virtual whiteboard, or any combination of such message types. E.g. the first user 106a can paste in or drag and drop video clips into the messaging field 210 and the clip will be send over the network 101 to the user(s) on the other end. Any such exchanges may be referred to herein as a “conversation”.

When the first user terminal 102a receives a contact request from the second user 106b, some dedicated UI elements are presented to the first user 106a in the conversation pane 204. These include a notification 214, 216 to the first user 106a that the second user 106b is requesting to become a contact (the notification identifying the second user 106b, e.g. by real-life name or username); and also two or more explicit, user-selectable options 217i, 217ii as to what to do about the request. These explicit options include at least an accept option 217i which and one or more other, negative options 217ii, where there one or more other options may comprise one or more of: decline, ignore, bock, and/or report as spam. E.g. these options 217i, 217ii may take the form of on-screen buttons. The first user 106a must therefore make an active decision as to whether to include the second user 106b amongst his or her contacts in the contact list 105. If the first user 106b does nothing, the second user 106b is never added as a contact and the contact request remains as a permanent or at least long-term item in the first user's history.

Thus the UI elements 214, 216 217 together form a conventional example of a “quarantine experience” 250, whereby the communication from the sending user 106b is quarantined until the receiving user 106a accepts him or her as a contact.

However, while the contacts model is beneficial for security, the particular mechanism described above also acts to unduly restrict the number of available connections between users, therefore inhibiting the utility of the system in terms of the volume of communications that are conducted and the number of combinations of endpoints between which those communications are conducted. Particularly, many contact requests are simply passively ignored by the receiving user 106a (rather than actively selecting an ignore option), even though that user might in fact know the requesting user 106b, and/or may even have gone on to communicate with him or her without accepting the contact request by instead using only one of the modes of communication allowed to non-contacts (e.g. a VoIP call).

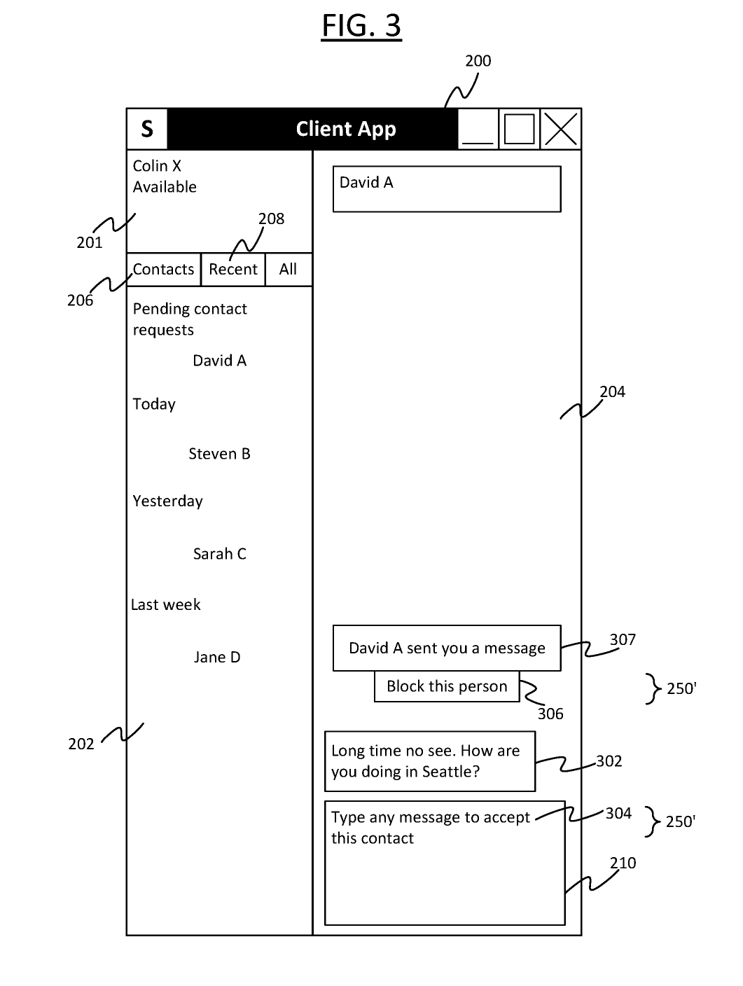

FIG. 3 illustrates a more “frictionless” mechanism in accordance with embodiments of the present disclosure. Elements in FIG. 3 are similar to those shown in FIG. 2 unless explained otherwise.

As shown in FIG. 3, the payload of the contact request received from the second user 106b contains a message 302 composed by the second user 106b. This message 302 is displayed to the first user 106a in the conversation pane 204. A notification 307 may also be displayed in the conversation window, but simply telling the user that the second user 106b sent them a message, rather than explicitly alerting the first user 106a to the fact that acceptance of a contact request is required. Further, there need not be any buttons or other such dedicated controls 217i, 217ii asking the first user to explicitly accept or not-accept the contact request. Instead, the first user 106a can implicitly accept the contact request by simply replying to the second user's message 302 with another message entered through the messaging field 210 of the conversation pane 204, just as if this was any other exchange of messages in a conversation between users who have already accepted one another as contacts.

The client application 103 or server 104 automatically detects that the first user 106a has replied to the second user 106b via the messaging field 210 on the first user's terminal 102a, and based thereon infers that the first user 106a is willing to communicate with the second user 106a and therefore to accept him or her as a contact. I.e. the act of the first user 106a interacting with the second user 106b is taken as tacit acceptance of the second user 106b as a contact. Thus in response to the reply sent by the first user 106a to the message 302 received in the second user's contact request, the second user 106b is automatically added to the first user's contact list 105—i.e. without separate user interaction by the first user 106c dedicated to the act of accepting the second user 106b as a contact. A note 304 to the first user 106a may also be displayed in the conversation pane 204 informing the first user 106a that replying to the message 302 will be taken as implicit approval of the second user 106b as a contact. E.g. this may be displayed in the messaging field 210, perhaps greyed out.

Thus there is provided a system for implicitly accepting a new sender 106b as a contact. Further, this is accompanied by a reduced quarantine experience 250′, consisting of a less obstructive UI mechanism 304, 306.

In embodiments, any interaction at all with the second user 106b is automatically taken as implicit acceptance of the contact request. E.g., so if the first user submits any outgoing IM message through the messaging field 210, this is taken as implicit acceptance of the second user 106b as a contact.

Alternatively, the client application 103 or server 104 (or a combination of them) may be configured to automatically process the actual content of the reply sent by the first user 106a through the messaging field 210, and based thereon make a decision as to whether the reply amounts to an acceptance. For example, the client 103 or sever 104 may be configured to recognize the presence of one or more of a set of predetermined negative words or phrases in the first user's reply, e.g. “Buzz off” or “Who are you?”, and in response to detecting any of these the second user 106b would not be automatically added as a contact (or even automatically blocked or reported as spam for certain subset of words or phrases). And/or, the client 103 or sever 104 may be configured to recognize the presence of one or more of a set of predetermined positive words or phrases in the first user's reply, e.g. “Nice to hear from you”, and in response to detecting any of these the second user 106b would be automatically added as a contact.

As another possibility, the client 103 or sever 104 may be configured to apply natural language processing techniques to the first user's reply, to try to extract the substantive meaning of the reply rather than relying on (or only on) the detection of predetermined phrases. The second user 106b may then be automatically added or not added depending on whether the extracted meaning is positive or negative (and in embodiments may even be blocked or reported as spam in dependence on the extracted meaning).

If on the other hand the first user 106a takes no action, the contact request is ignored.

Note also, in embodiments, the reply by the first user 106a does not have to be an IM message. In embodiments a reply in the form of any of a set of possible message types submitted through the messaging field 210 may implicitly cause an automatic acceptance, where said set may comprise any one, some or all of: an IM message or other text-based message, a voice or video call (e.g. VoIP call), a pre-recorded video clip (video message), a still image (picture message), a pre-receded audio clip (e.g. voice mail), a shared location of the first user 106c (e.g. from a satellite based positioning system or indoor location system), a slide show, a screen share, and/or content from an electronic or virtual whiteboard. For instance, the first user 106a may implicitly accept the second user 106b as a contact by answering an incoming voice and/or video call from the second user 106b.

In embodiments, a block option 306 and/or report as spam option, may be floated in the conversation pane 204 (e.g. a button or hypertext). If the first user 106b actuates the block option 306 then the second user 106b will be prevented from sending any more contact requests and any other attempts at communication (e.g. requesting a VoIP call), or at least such attempts and requests will not be displayed to the first user 106b if made. If the first user 106a actuates the report as spam option, then not only is the second user 106b blocked as discussed above, but a complaint is also triggered to be logged at the server 104, where such complaints from multiple users 106 can be analysed in order to identify and remove from the system serial spammers.

Note however that even in the case where a block option 306 or report as spam option is displayed in the conversation pane 204, the first user 106a is still not prompted with an explicit positive user-operable control 217i separate to the messaging field 210 as in FIG. 2. I.e. it still does not use an explicit accept/decline or accept/ignore paradigm, or the like, as in the conventional case of FIG. 2.

In embodiments, as another alternative or additional precaution against abuse, restrictions are placed on the message 302 in the contact request compared to messages that can be exchanged between already-accepted contacts. E.g. the message 302 may be restricted to only contain text, and not any “rich content” (e.g. no audio, images nor video; no files; no software; and/or no links). And/or, the message length may be restricted compared to normal messages between contacts. E.g. the message 302 may be restricted to a certain predetermined maximum number of characters, such as two-hundred; whereas an IM message sent in a conversation between contacts may have a higher limit, e.g. 1000 characters, or may have no limit at all. And/or, the number of times a contact request can be sent may be limited to a certain predefined maximum number, e.g. five, whereas no restriction may be placed on the number of IMs that can be sent between contacts (or at least a much higher limit).

In particular embodiments of this, such restrictions may be made configurable, either by the first user 106i or the operator of the communication system in question. E.g. if one or more such restrictions are implemented as settings in the server 104, this allows the operator of the communication system to modify rules over time as they observe how the restrictions currently being implemented are affecting reports of spam and/or abuse. For instance, one such configurable setting may be the number of combinations that a sender 106b can send to a given recipient 106b before being accepted as a contact of that recipient (after which any such communications are automatically blocked).

In yet further embodiments, the second user 106b has a similar UI 200 displayed on his or her user terminal 102b at the side sending the contact request. In such embodiments, optionally the second user 106b may be enabled to send a contact request by entering a message to send to the first user 106a through the message field 210 (e.g. having found the first user 106a through search tool or an auto-recommendation feature). I.e. the sending user 106b does not have to explicitly select a send contact request option through the UI 200, but rather the experience of sending a contact request is made to feel just like sending a normal IM message. Again this makes for a much more frictionless mechanism for connecting users whilst retaining the contacts-based security model.

Note however that in embodiments, although the contact request 302 can contain a message 302 in its payload, the contact request is still a separate, pre-existing mechanism of the communication system, separate from the IM messages exchanged between existing contacts. That is, the mechanism disclosed above re-uses a pre-existing contact request format of the communication system, which has a smaller payload and a different message type ID than an IM message (and indeed in embodiments, a different message type ID than any other type of message designed for sending user content between existing contacts).

Turning now to the quarantine experience 250, as already introduced above, the present disclosure provides an adaptive quarantine mechanism for incoming communications from non-contacts, wherein the adaptive quarantine mechanism imposes a varying degree of quarantining on the incoming communication in dependence on one or more factors relating to the incoming communication. Such factors may comprise for example: one or more factors indicative of a relationship between the first user 106a and the second user 106b (are they already associated by some other means?), and/or one or more factors relating to the nature of the incoming communication (e.g. is it a call or IM?), and/or one or more factors relating to the second user 106b (e.g. an indication of his or her reputation). The evaluation of these factors provides the adaptive quarantine mechanism with an estimate of a degree of trust in the second user 106b.

Based on such factors, the adaptive quarantine mechanism selects between at least two different quarantine levels in accordance with the degree of trust that can be inferred: (I) a higher (stricter) level of quarantining if the evaluation of the one or more factors is indicative a lower degree of trust, and (II) a lower (more permissive) level of quarantining if the one or more factors is indicative of a higher degree of trust.

The adaptive quarantine mechanism may be implemented at the client side, in the client application 103a of the first user 106a; or at the server side, in the server of the provider of the communication system in question. The adaptive quarantine mechanism may also be implemented as a combination of client side and server side implementations.

In embodiments, the high quarantine level may comprise prompting the first user with only the reduced quarantine experience 250′ as exemplified in FIG. 3, and allowing the second user 106b to be accepted as a contact of the first user 106a based on the implicit contact acceptance mechanism; whilst the low quarantine level may comprise no quarantining at all, such that, once the second user has been determined to meet the relevant test of trust based on said one or more factors, then the second user 106b is automatically accepted as one of the first user's contacts without any action being required from the first user 106b.

Alternatively, the high quarantine level may comprise prompting the first user 106a with the full quarantine experience 250 as exemplified in FIG. 2, i.e. explicit UI controls for both block 217ii and accept 217i; whilst the low quarantine level may comprise prompting the first user with only the reduced quarantine experience 250′ as exemplified in FIG. 3, and allowing the second user 106b to be accepted as a contact of the first user 106a based on the implicit contact acceptance mechanism.

As another alternative, both the high and the low quarantine levels may use the implicit contact acceptance mechanism, but only the higher quarantine level explicitly displays the quarantine experience 250′, whereas when the lower quarantine level is selected then no quarantine experience 205/250′ is presented in response to the receipt of the communication from the second user 106b (the implicit acceptance goes on completely behind the scenes as far as the first user 106a is concerned).

As yet another alternative, the high quarantine level may comprise the traditional experience such as shown in FIG. 2, whilst the low quarantine level may comprise no quarantining at all (automatic acceptance). In this variant the implicit contact acceptance mechanism is not involved in either scenario.

As yet another possibility, there could even be three or more quarantine levels depending on the outcome of evaluating the one or more factors (i.e. the mechanism recognizes three or more categories of trust). For instance, in a high quarantine level may be imposed for the lowest degree of trust, the traditional (strictest) model may be applied such as described in relation to FIG. 3 (explicit acceptance required); whereas in a medium level allowed for a medium degree of trust, the reduced model such as described in relation FIG. 3 may be applied (implicit acceptance enabled); and for the lowest level allowed for the highest degree of trust, no quarantining may be applied (fully automated acceptance).

Note that even where the second user 106b has been implicitly or automatically selected as contact, preferably the user interface 200 of the client application 103 still provides a control by which the first user 106a can still undo this so as to disallow (and therefore block) the second user 106b as a contact (i.e. so future communications from the second user 102b will be blocked). However, in the case where no quarantine experience is presented upon receipt of the initial incoming communication from the second user 106b, this control will be hidden behind at least one other UI control and is not presented visibly in the UI 200 upon receipt of the incoming communication. I.e. the first user has to actuate another UI control in order to summon the block control. For example, the first user 102a has to navigate to the contacts pane 202 by selecting the contacts control 202, then select one the second user 106b from the contact list (such as by right clicking, touching or touching-and-holding) in order to summon the block control to block the second user 106b after that user has already been accepted.

In embodiments, the system is configured to store a conversation history comprising a record of some or all of the communications conducted between the first user 106a and the second user 106b via the communication system, before and/or after the second user 106b is added as a contact of the first user 106a. Preferably the history stores a record of all the communications between the first and second users 106a, 106b both before and after the second user 106b is accepted as a contact of the first user 106a. In embodiments, this may either be stored locally on the first user terminal 102a or on the server 104, or a copy may be stored in both locations. Furthermore, in embodiments, the quarantine mechanism may be configured to automatically delete some or all of the local and/or server-hosted conversation history in response to the first user 106a selecting to block the second user 106b. This may comprise automatically deleting the history from before and/or after the second user 106b was accepted as a contact of the first user 106a. Preferably this comprises automatically deleting, at least locally, all of the conversation history between the first and second users 106a, 106b both before and after the second user 106b was accepted as a contact of the first user 106a (or at least all the communications exclusively between the first and second users 106a, 106b both before and after the second user 106b was accepted as a contact of the first user 106—i.e. a history of multiparty conversations involving the first user 106a, the second user 106b and one or more third users 106c,d,e may be retained). In some embodiments, only the local conversation history is automatically deleted when the second user 106b is blocked. This way, the conversation history can be recovered if the first user 106a later unblocks the second user 106a and re-accepts him or her as a contact.

Regarding the rule or rules for selecting between the different quarantine levels in dependence on one or more factors relating to the incoming communication, there are a number of possibilities for implementing these.

For instance, in embodiments the adaptive quarantine mechanism may be arranged to have access to the contact list 105 of the first user 103a and also the contact list of the second user 106b. In this case the adaptive quarantine mechanism is able to assess what other contact(s), if any, the first and second users 106a, 106b share from common in their respective contact lists. Based on this, in embodiments the adaptive quarantine mechanism may be configured to allow the reduced quarantine level on condition for the incoming communication from the second user 106b on condition that the first and second users 106a, 106b share at least x contacts in common (where x may be 1 or may be greater than 1). In embodiments x may be a configurable setting that can be varied by the first user 106a, or by the provider of the communication system.

Alternatively, or additionally, as another example, the adaptive quarantine mechanism may be arranged to have access to an address book of the first user 103a and also to the profile of the second user 106b. The address book of the first user, which may be stored on the first terminal 102a or on the server 104, stores one or more addresses of people the first user 104 knows, wherein the addresses are for addressing these people via some other communication means other than the commination system through which the incoming communication from the second user 106b is received (e.g. other than a user name of the VoIP or IM system in question). So for example the one or more addresses in the address book may comprise one or more phone numbers (for addressing one or more people via a PSTN network) and/or email addresses of one or more people (for addressing them over the Internet but by email rather than, say, VoIP or IM). Furthermore, the profile of the second user 106b also comprises at least one such address of the second user 106b, for addressing the second user 106b via the alternative communication means. In such an arrangement, the adaptive quarantine mechanism is able to assess the first user 106a already has the address of the second user 106b in his or her address book. If so, this is an indication that the first and second users 106a, 106b already know each other via some other medium (e.g. PSTN or email), even though they happen not to be connected yet through the particular communication system (e.g. VoIP or IM) through which the incoming communication in question is received. Thus, on condition of finding at least y addresses of the second user 106b in the address book to the first user, in embodiments the adaptive quarantine mechanism may be configured to apply the reduced quarantine level (where y may be 1 or may be greater than 1). In embodiments y may be a configurable setting that can be varied by the first user 106a, or by the provider of the communication system.

As another alternative or additional example, the adaptive quarantine mechanism has access to a conversation history of past multiparty conversations (i.e. involving three or more participants all communicating with one another in a given session, e.g. a given IM session, VoIP call or video call). Such a history may be stored on the first user terminal 102a, or on the server 104, or on the second user terminal 102b. Some multiparty conversations may involve users who are not contacts of one another, such as the first and second users 106a, 106b in the present examples, because they may be added as participants by a third participant who is a contact of both. Thus with access to the multiparty conversation history, this gives the adaptive quarantine mechanism a similar insight as the common-contact case described above. Furthermore, this may indicate an even greater degree of trust than simply having a shared contact per se, because it can be seen that the first and second users 106a, 106b have actually communicated with one another in the past (e.g. been on the same VoIP call). Thus in embodiments, the adaptive quarantine mechanism may be configured to allow the reduced quarantine level for the incoming communication from the second user 106b on condition that the first and second users 106a, 106b have been participants together in at least z multiparty communication sessions in the past (where z may be 1 or may be greater than 1). In embodiments z may be a configurable setting that can be varied by the first user 106a, or by the provider of the communication system.

As another alternative or additional example, the adaptive quarantine mechanism may be arranged to have access to a list of one or more groups populated by various people. E.g. the adaptive quarantine mechanism may have access to the profiles of the first and second users 106a, 106b, on the server 104 of the communication system (e.g. the VoIP/IM system), where users advertise to one another that they are members of a certain special interest group or groups. And/or, adaptive quarantine mechanism may have access to data from one or more social media sites via the Internet (hosted on other parties' servers, not shown), where users also advertise themselves as members of certain special interest groups (e.g. trainspotting, volleyball, etc.). If based on its access to the lists of people in one or more groups, the adaptive quarantine mechanism can see that the first and second users 106a, 106b are members of one or more of the same group or groups, this may be an indication that they share a sufficient amount in common to want to allow one to contact the other. E.g. if both the first and second users 106a, 106b are members of both the trainspotting and volleyball fan-clubs, it is likely that the first user 106a would like to receive communications from the second user 106b. In general, any group categorization of users can be used to infer such commonality. Thus in embodiments, the adaptive quarantine mechanism may be configured to allow the reduced quarantine level for the incoming communication from the second user 106b on condition that the first and second users 106a, 106b are members of at least n of the same groups (where n may be 1 or may be greater than 1). In embodiments n may be a configurable setting that can be varied by the first user 106a, or by the provider of the communication system.

As another alternative or additional example, the adaptive quarantine mechanism may be arranged to have access to the communication records of one or more other communication systems, other than that through which the incoming communication from the second user 106b is received (e.g. other than the VoIP and/or IM system in question). Such records may be hosted on respective servers of the provider(s) of the one or more other communication systems (not shown), and may be access by the adaptive quarantine mechanism via the Internet 101. In such cases, based on the access to said records, the adaptive quarantine mechanism may be configured to allow the reduced quarantine level for the incoming communication from the second user 106b on condition that the first and second users 106a, 106b have communicated with one another at least m times via one or more of the other communication systems (where m may be 1 or may be greater than 1). In embodiments m may be a configurable setting that can be varied by the first user 106a, or by the provider of the communication system.

In a further alternative or additional example, the adaptive quarantine mechanism may have access to the profiles of both the first and the second users 106a, 106b, and may compare these to check for a potential link between the first and the second users 106a, 106b. For instance, if the adaptive quarantine mechanism can see from the users' profiles they share a surname (family name) then this indicates they may be related. Or if both users 106a, 106b have chosen to advertise in their profiles that they have a familial relationship with one another, or are friends of one another, or are in an amorous relationship with one another, this again indicates they know one another. Thus in embodiments, the adaptive quarantine mechanism may be configured to relax the quarantine level for an incoming communication from the second user 106b on condition that a match is found in a certain predetermined common element of the profiles of the first and second users 106a, 106b, or on condition that at least k matches are found between the profiles of the first and second users 106a, 106b (where k may be 1 or may be greater than 1). In embodiments k may be a configurable setting that can be varied by the first user 106a, or by the provider of the communication system. And/or which predetermined element or elements must match may be a configurable setting settable by the first user or provider.

As another alternative or additional example, the adaptive quarantine mechanism may be arranged to have access to information on the location of. For example, it may have access to a localization system for tracking the location of the first user terminal 102a, e.g. a satellite-based localization system such as GPS, GLONASS or Galileo; or another type of positioning system such as indoor positioning system, or a system based on sniffing signals from pre-existing nodes such as cell towers and wireless access points. Another example is Geo IP. Furthermore, the second user 106b may share the location of the second user terminal 102b, e.g. making it available to the adaptive quarantine mechanism via the server 104. This could again be detected by any suitable localization system such as those outlined above. In such cases, the adaptive quarantine mechanism may be configured to relax the quarantine level for an incoming communication from the second user 106b on condition that the locations of the first and second user terminals are within a predetermined proximity of one another, e.g. within a predetermined radius, or both within a predetermined zone (e.g. same street or building).

In further embodiments, the quarantine decision may be further made dependent on the length of time any one or more of the above relationships has already existed for at the point in time at which the incoming communication from the second user 106b is received. I.e. the adaptive quarantine mechanism may be configured such that the quarantine level is selected in dependence on said length of time, such that if the relationship has existed for at least a certain minimum threshold amount of time T then a lower (more trusting) quarantine level is selected, but otherwise a higher (less trusting) quarantine level is selected. In embodiments T may be a configurable setting that can be varied by the first user 106a, or by the provider of the communication system.

In yet another alternative or additional example, different types of communication may be treated differently, e.g. different combinations of rules for different ones of IMs, calls, picture messages, video messages, voicemails and/or screen-shares. For example, calls may be subject to a lower quarantine level with a lesser quarantine experience compared to IM messages (because VoIP as a medium tends not to attract as much spam as

In yet another alternative or additional example, the server 104 may maintain records of a quantitative measure of the reputation of one or more of the users, including at least the second user 106a. For example, one way to measure reputation (in a communication system) is to keep a running record of the ration between the number of times the second user 106b has been accepted as a contact (whether automatically or explicitly) and the number of times the second user 103 has been rejected as a contact (clocked), over multiple past occasions on which the second user 106b has attempted to contact other users 106 in the system. Other such metrics for measuring reputation include for example a spam rate (e.g. based on recipients' reports of spam), or sending rate (if the second user 106b sends out too many messages per unit time this could be an indication of a spammer). In any such embodiment, the adaptive quarantine mechanism may be arranged to have access to at least one such reputational metric for the second user 106b, and to relax the quarantine level for an incoming communication from the second user 106b on condition that this metric is beyond a certain predefined threshold.

Any of the above-described adaptive quarantine mechanisms may be implemented in the communication client 103a of the first user, or may be implemented partially in the client 103a and partially at the server 104. The part that outputs the quarantine experience 250/250′ may be implemented at the client side 103a, or may be hosted on the server 104 in the case of a web-hosted client accessed through a general purpose client such as a web browser on the first user terminal 102a. The one or more rules for making the quarantine decision may be implemented locally on the user terminal 102a, or on the server 104. Where the rules comprise a configurable setting or settings, the setting(s) may be stored on the first user terminal 102a or on the server (not necessarily at the same location as the rules themselves, though they may be). Further, the part that evaluates the one or more rules may be implemented at the client side in the client 103a on the first user terminal 102a, or at the server side on the server 104. In embodiments, a server-side implementation for at least the storage of the rule(s) and/or setting(s) may be preferred, as this allows an operator to adapt the rules over time based on observations of how the current rule(s) and/or setting(s) are affecting reports of spam and/or abuse

It will be appreciated that the above embodiments have been described by way of example only.

More generally, according to one aspect disclosed herein there is provided a method comprising: from a first user terminal, a first user accessing a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts; at the first user terminal, receiving an incoming communication via said communication system originating from a second user of a second user terminal, the second user being one of the other users who is not yet one of the contacts of the first user; and in dependence on one or more factors relating to the incoming communication, automatically selecting between: a) prompting the first user with a quarantine experience in a user interface on the first terminal upon the receipt of said incoming communication, the quarantine experience offering the first user an option to block further attempts by the second user to communicate with the first user via said communication system, or instead b) not prompting the first user with a quarantine experience upon the receipt of said incoming communication or only prompting the first user with a reduced quarantine experience upon the receipt of the incoming communication, such that the second user can be accepted as one of said contacts without the first user being prompted with a quarantine experience or with the first user only being prompted with the reduced quarantine experience.

In embodiments, the quarantine experience may comprise an option for the first user to report said incoming communication as spam or abuse.

In embodiments the quarantine experience may also offers an option for the first user to accept the second user as one of the contacts.

In embodiments, the method may comprise providing an implicit contact acceptance mechanism through the user interface on the first terminal, whereby in response to the first user sending a reply to said incoming communication back to the second user via said communication system, the reply comprising user content composed, captured or chosen by the first user, then the second user is automatically added as one of said contacts without the first user having to actuate any explicit contact acceptance control.

In embodiments, the user content may comprise text composed by the first user, or audio or image data composed, captured or selected by the first user, or a geographic location of the first user which the first user has chosen to share.

In embodiments a) or b), but not both, may comprise automatically accepting the second user as one of said contacts through the implicit contact acceptance mechanism. For instance, a) may comprise presenting the user with explicit block and accept controls, whilst b) may comprise enabling the implicit contact acceptance mechanism. Alternatively, a) may comprise the use of the implicit contact acceptance mechanism, while b) may comprise automatically accepting the second user as one of said contacts upon the receipt of said communication without requiring any action from the first user.

In embodiments, the method may comprise: in a conversation area of the user interface on the first terminal, providing a messaging field in which the first user can enter content to be communicated to selected ones of the other users as part of two-way conversations conducted via said communication system; wherein according to the implicit contact acceptance mechanism, the second user may be automatically accepted as one of said contacts of the first user in response to the first user entering the reply to said incoming communication through the messaging field.

In embodiments the messaging field may enable the first user to send IM messages as at least part of said content of a conversation, and said reply may comprise an IM message. In embodiments the messaging field may enable the first user to send still images as at least part of said content of a conversation, and said reply may comprise a still image. In embodiments, the messaging field may enable the first user to send video messages as at least part of said content of a conversation, and said reply may comprise a video message. In embodiments the messaging field may enable the first user to share a geographic location of the first user as at least part of said content of a conversation, and said reply may comprise a shared location of the first user entered through the messaging field.

In embodiments, said incoming communication may comprise an IM message, a picture message, and/or a video message.

In embodiments, said incoming communication may comprise a call establishment request whereby the second user requests to establish voice or video call with the first user, and said reply may comprise answering the call, the user content comprising outgoing audio and/or video content of the call.

In embodiments said one or more factors may comprise one or more indicators of a relationship between the first and second user, said automatic selection being performed in dependence on said one or more indicators.

For instance the one or more indicators of said relationship may comprise one or more of: (i) a number of contacts the first user and second user have in common, wherein b) is selected on condition that the first and second users have a minimum threshold number of contacts in common; (ii) a number of addresses of the second user found in an address book of the first user for communicating with the second user another communication medium other than said communication system, wherein b) is selected on condition that the first user has at least a minimum threshold number of said addresses in his or her address book; (iii) a number of times the first user and second user have previously been added into a same group conversation by another user, wherein b) is selected on condition that the first and second users have previously both been added to the same group conversation at least a minimum threshold number of times; (iv) a number of groups the first and second user both belong to, wherein b) is selected on condition that the first and second users both belong to at least a minimum threshold number of the same groups; (v) a number of times the first and second users have already communicated previously via another communication medium other than said communication system, wherein b) is selected on condition that the first and second users have previously communicated with one another via another communication medium at least a minimum threshold number of times, and/or b) is selected on condition that the first and second users or have previously communicated with each other via at least a minimum threshold number of other communication media; (vi) a number of matches found in a comparison between elements of a profile of the first user and elements of a profile of the second user, wherein b) is selected on condition that at least a minimum threshold number of matches between the profiles is found; (vii) whether or not a match is found between a particular predetermined set of one or more common elements of a profile of the first user and a profile of the second user, wherein b) is selected on condition of the match in said predetermined element; and/or (viii) a location of the second user relative to the first user, wherein b) is selected on condition of the location of the second user being within a predetermined proximity of the first user.

Said minimum threshold number may be one, i.e. so a) is selected if the number is zero, but otherwise if the number is one or more then b) is selected. Alternatively, the minimum threshold may be more than one.

In embodiments, said minimum threshold number may be a configurable setting settable by the first user or by a provider of the communication service.

In embodiments, said automatic selection may be performed in further dependence on said relationship having existed for a minimum threshold amount of time.

In embodiments, said one or more factors may comprise a type of the incoming communication determined from amongst a set of predefined communication types, the set of predefined communication types comprising two or more or: IM, call establishment request, picture message, voicemail, and/or screen sharing request. For instance, b) may be selected if the type of the incoming communication is a call establishment request whereas a) may be selected if the type of the incoming communication is an IM.

In further embodiments said one or more factors may comprise one or more characteristics of the second user. E.g. said one or more characteristics may comprise an indication of a reputation of the second user.

In embodiments, the number of communications the second user can send to the first user before being accepted as one of said contacts may be limited to a predetermined number.

In embodiments, the user interface may still make available a block option for blocking the second user, but the block option has to be manually summoned by the first user via another user interface element and is not automatically presented to the first user upon the receipt of said incoming communication.

In embodiments, the method may further comprise automatically deleting a history of communications between the second and first users in response to the first user selecting to block the second user.

In embodiments, said automatic selection in dependence on said one or more factors may be performed by: having the one or more factors evaluated at least partially at a server; the first user receiving from the server an indication as to a result of the evaluation performed at the server, or an indication as to which of a) and b) to select based on the evaluation performed at the server; and the first user terminal acting upon said indication from the server.

In embodiments, said one or more permissions may comprise one or more of: permission to send IM messages to the first user via the communication system, permission to initiate a voice call with the first user via the communication system, permission to initiate a video call with the first user via the communication system, permission to view a presence status of the first user via the communication system, permission to view a status message of the first user via the communication system, and/or permission to view a geographic location of the first user via the communication system. In embodiments, said one or more permissions may comprise: permission to be treated according to a first set of communication preferences set by the first user for the contacts rather a second set of communication preferences set by the second user for non-contacts.

In embodiments, said one or more factors may be evaluated at least partially at the first user terminal.

Alternatively, or additionally, said automatic selection in dependence on said one or more factors is performed by: having the one or more factors evaluated at least partially at a server; the first user receiving from the server an indication as to a result of the evaluation performed at the server, or an indication as to which of a) and b) to select based on the evaluation performed at the server; and the first user terminal acting upon said indication from the server.

According to another aspect disclosed herein, there is provided a computer program product embodied on computer-readable storage and configured so as when run on the one or more processors to cause the method of any of the above embodiments to be performed.

Other variants and use cases may become apparent to a person skilled in the art once given the disclosure herein. The scope of the disclosure is not limited by the described embodiments but only by the accompanying claims.

1. A method comprising:
from a first user terminal, a first user accessing a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts;
at the first user terminal, receiving an incoming communication via said communication system originating from a second user of a second user terminal, the second user being one of the other users who is not yet one of the contacts of the first user; and
in dependence on one or more factors relating to the incoming communication, automatically selecting between: a) prompting the first user with a quarantine experience in a user interface on the first terminal upon the receipt of said incoming communication, the quarantine experience offering the first user an option to block further attempts by the second user to communicate with the first user via said communication system, or instead b) not prompting the first user with a quarantine experience upon the receipt of said incoming communication or only prompting the first user with a reduced quarantine experience upon the receipt of the incoming communication, such that the second user can be accepted as one of said contacts without the first user being prompted with a quarantine experience or with the first user only being prompted with the reduced quarantine experience.

2. The method of claim 1, wherein the quarantine experience comprises an option for the first user to report said incoming communication as spam or abuse.

3. The method of claim 1, wherein the quarantine experience also offers an option for the first user to accept the second user as one of the contacts.

4. The method of claim 1, comprising:
providing an implicit contact acceptance mechanism through the user interface on the first terminal, whereby in response to the first user sending a reply to said incoming communication back to the second user via said communication system, the reply comprising user content composed, captured or chosen by the first user, then the second user is automatically added as one of said contacts without the first user having to actuate any explicit contact acceptance control.

5. The method of claim 4, wherein the user content comprises text composed by the first user, or audio or image data composed, captured or selected by the first user, or a geographic location of the first user which the first user has chosen to share.

6. The method of claim 4, wherein a) or b), but not both, comprises automatically accepting the second user as one of said contacts through the implicit contact acceptance mechanism.

7. The method of claim 4, comprising:
in a conversation area of the user interface on the first terminal, providing a messaging field in which the first user can enter content to be communicated to selected ones of the other users as part of two-way conversations conducted via said communication system; and
wherein according to the implicit contact acceptance mechanism, the second user is automatically accepted as one of said contacts of the first user in response to the first user entering the reply to said incoming communication through the messaging field.

8. The method of claim 7, wherein one of:
the messaging field enables the first user to send IM messages as at least part of said content of a conversation, and said reply comprises an IM message;
the messaging field enables the first user to send still images as at least part of said content of a conversation, and said reply comprises a still image;
the messaging field enables the first user to send video messages as at least part of said content of a conversation, and said reply comprises a video message;
the messaging field enables the first user to share a geographic location of the first user as at least part of said content of a conversation, and said reply comprises a shared location of the first user entered through the messaging field.

9. The method of claim 1, wherein said incoming communication comprises an IM message, a picture message, and/or a video message.

10. The method of claim 4, wherein said incoming communication comprises a call establishment request whereby the second user requests to establish voice or video call with the first user, and wherein said reply comprises answering the call, the user content comprising outgoing audio and/or video content of the call.

11. The method of claim 1, wherein the one or more factors comprise one or more indicators of a relationship between the first and second user, said automatic selection being performed in dependence on said one or more indicators:

12. The method of claim 11, wherein the one or more indicators of said relationship comprise one or more of:
a number of contacts the first user and second user have in common, wherein b) is selected on condition that the first and second users have a minimum threshold number of contacts in common;
a number of addresses of the second user found in an address book of the first user for communicating with the second user another communication medium other than said communication system, wherein b) is selected on condition that the first user has at least a minimum threshold number of said addresses in his or her address book;
a number of times the first user and second user have previously been added into a same group conversation by another user, wherein b) is selected on condition that the first and second users have previously both been added to the same group conversation at least a minimum threshold number of times;
a number of groups the first and second user both belong to, wherein b) is selected on condition that the first and second users both belong to at least a minimum threshold number of the same groups;
a number of times the first and second users have already communicated previously via another communication medium other than said communication system, wherein b) is selected on condition that the first and second users have previously communicated with one another via another communication medium at least a minimum threshold number of times, and/or b) is selected on condition that the first and second users or have previously communicated with each other via at least a minimum threshold number of other communication media;
a number of matches found in a comparison between elements of a profile of the first user and elements of a profile of the second user, wherein b) is selected on condition that at least a minimum threshold number of matches between the profiles is found;
whether or not a match is found between a particular predetermined set of one or more common elements of a profile of the first user and a profile of the second user, wherein b) is selected on condition of the match in said predetermined element; and/or
a location of the second user relative to the first user, wherein b) is selected on condition of the location of the second user being within a predetermined proximity of the first user.

13. The method of claim 11, wherein said automatic selection is performed in further dependence on said relationship having existed for a minimum threshold amount of time.

14. The method of claim 1, wherein said one or more factors comprise a type of the incoming communication determined from amongst a set of predefined communication types, the set of predefined communication types comprising two or more or: IM, call establishment request, picture message, voicemail, and/or screen sharing request.

15. The method of claim 1, wherein the number of communications the second user can send to the first user before being accepted as one of said contacts is limited to a predetermined number.

16. The method of claim 1, wherein the user interface still makes available a block option for blocking the second user, but the block option has to be manually summoned by the first user via another user interface element and is not automatically presented to the first user upon the receipt of said incoming communication.

17. The method of claim 1, further comprising automatically deleting a history of communications between the second and first users in response to the first user selecting to block the second user.

18. The method of claim 1, wherein said automatic selection in dependence on said one or more factors is performed by:
having the one or more factors evaluated at least partially at a server;
the first user terminal receiving from the server an indication as to a result of the evaluation performed at the server, or an indication as to which of a) and b) to select based on the evaluation performed at the server; and
the first user terminal acting upon said indication from the server.

19. A computer program product embodied on computer-readable storage and configured so as when run on the one or more processors to cause the following operations to be performed:
from a first user terminal, a first user accessing a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts;
at the first user terminal, receiving an incoming communication via said communication system originating from a second user of a second user terminal, the second user being one of the other users who is not yet one of the contacts of the first user; and
in dependence on one or more factors relating to the incoming communication, automatically selecting between: a) prompting the first user with a quarantine experience in a user interface on the first terminal upon the receipt of said incoming communication, the quarantine experience offering the first user an option to block further attempts by the second user to communicate with the first user via said communication system, or instead b) not prompting the first user with a quarantine experience upon the receipt of said incoming communication or only prompting the first user with a reduced quarantine experience upon the receipt of the incoming communication, such that the second user can be accepted as one of said contacts without the first user being prompted with a quarantine experience or with the first user only being prompted with the reduced quarantine experience.

20. A first user terminal comprising:
A network interface for enabling a first user to access a communication system for communicating with a plurality of other users of other user terminals via a network, wherein the communication system maintains a list of contacts of the first user, the contacts being ones of the other users who have been accepted by the first user as contacts, and who are thereby granted one or more permissions in relation to communicating with the first user via the communication system, said one or more permissions not being granted to any of said other users who are not amongst the contacts;
processing apparatus arranged to run a communication client application for receiving an incoming communication via said communication system and interface originating from a second user of a second user terminal, the second user being one of the other users who is not yet one of the contacts of the first user;
wherein the communication client application is configured so as when run on the processing apparatus to:
in dependence on one or more factors relating to the incoming communication, automatically select between: a) prompting the first user with a quarantine experience in a user interface on the first terminal upon the receipt of said incoming communication, the quarantine experience offering the first user an option to block further attempts by the second user to communicate with the first user via said communication system, or instead b) not prompting the first user with a quarantine experience upon the receipt of said incoming communication or only prompting the first user with a reduced quarantine experience upon the receipt of the incoming communication, such that the second user can be accepted as one of said contacts without the first user being prompted with a quarantine experience or with the first user only being prompted with the reduced quarantine experience.
